(19) United States
(12) Patent Application Publication
(10) Pub. No.: US 2008/0312070 A1
(43) Pub. Date: Dec. 18, 2008

(54) Method for Making a Material

(76) Inventors: Peter Cade Talbot, Chapel Hill (AU); Geoffrey Alan Edwards, Coolum Beach (AU); Jose Antonio Alarco, Indrooroopilly (AU)

Correspondence Address: WINSTON & STRAWN LLP;PATENT DEPARTMENT, 1700 K STREET, N.W., WASHINGTON, DC, 20006, US

(21) Appl. No.: 11/914,213

(22) PCT Filed: May 5, 2006
(86) PCT No.: PCT/AU2006/000597

§ 371 Date: May 30, 2008

Related U.S. Application Data
(60) Provisional application No. 60/680,790, filed on May 12, 2005.
(60) Provisional application No. 60/695,698, filed on Jun. 29, 2005.
(60) Provisional application No. 60/695,647, filed on Jun. 29, 2005.

(30) Foreign Application Priority Data
Nov. 9, 2005 (AU) 200506207
Mar. 13, 2006 (AU) 200601309
Mar. 13, 2006 (AU) 2006901315

(51) Int. Cl. B01J 21/16; B01J 23/02; B01J 23/04; B01J 23/06; B01J 23/10; B01J 23/20; B01J 23/26; B01J 23/28; B01J 21/06; B01J 29/00; B01J 23/34; B01J 23/36; B01J 23/40; B01J 23/42; B01J 23/44; B01J 23/50; B01J 23/52

(52) U.S. Cl. 502/80; 502/303; 502/232; 502/159; 502/87; 502/325; 502/302; 502/340; 502/344; 502/353; 502/349; 502/355; 502/304; 502/350; 502/319; 502/324; 502/337; 502/345; 502/343; 502/321; 502/339; 502/347

(57) ABSTRACT

The invention relates to a method for forming a material of a metal oxide supported on a support particle by the steps of. a) providing a precursor mixture comprising a solution containing one or more metal cations and (i) a surfactant; or (ii) a hydrophilic polymer; with the precursor mixture further including support particles; and b) treating the precursor mixture from (a) above by heating to remove the surfactant or hydrophilic polymer and form metal oxide having nano-sized grains, wherein at least some of the metal oxide formed in step (b) is deposited on or supported by the support particles and the metal oxide has an oxide matrix that includes metal atoms derived solely from sources other than the support particles.

### FIELD OF THE INVENTION

The present invention relates to a method for making a material. The present invention particularly relates to a method for making a material in which a metal oxide material is supported on a support. The metal oxide material may be catalytically active.

### BACKGROUND TO THE INVENTION

Catalysts are widely used in a large number of industries. Some examples of industries that utilise catalysts include oil refining (especially cracking and reforming), automotive manufacture (especially exhaust catalysts, such as three way catalysts), plastics manufacturing, production of synthesis gas, chemical synthesis processors, absorption and fuel cell manufacture.

A wide range of catalysts are of the type known as supported catalysts. In these catalysts, a catalytic material is supported on a support substrate. The support substrate may be in the form of powder, particles or monoliths. The support substrate is normally selected on the basis of the substrate being able to resist the conditions under which the catalyst is used. It will be appreciated that the conditions under which the catalyst is used may include one or more of elevated temperature, elevated pressure, and aggressive chemical environments. The support substrate may be relatively inert or it may itself have some catalytic activity. Support catalysts also include a catalytic material supported on the support substrate.

The catalytic activity of supported catalysts will primarily be a function of:

(a) The specific catalytic activity of the particular catalytic material supported on the support material;

(b) The amount of catalytic material supported on the support material; and

(c) The surface area of the catalytic material on the support material.

With regard to (a) above, it is know that some catalytic materials have 30 greater catalytic activity (or a greater catalysing effect) for a particular reaction. For example, noble metals are known to be effective at catalysing the oxidation of automotive exhaust gases.

With regard to (b) above, a higher loading of catalytic material on the support material should, all things otherwise being equal, increase the amount of catalytic material available to catalyse reactions. Similarly, with regard to (c) above, as it is the surface of the catalytic material that is involved in the catalysed reaction, a larger surface area of catalytic material should provide for an increased reaction rate.

Thus, it is expected that the best supported catalyst for any particular application would have the most catalytically active catalytic material present on the support material at as higher loading as possible and presenting the highest surface area as possible. However, in practice, a number of other factors must also be taken into consideration. For example, the most catalytically active material for a particular application may be prohibitively expensive. The supported catalyst may be difficult to manufacture, or it may degrade (i.e. lose its catalytic activity) over time. Degradation of catalytic performance may arise due to poisoning of the catalytic material, loss of catalytic material from the support (such as by leaching, erosion or abrasion) or by loss of surface area due to diffusion and growth of the catalytic material at elevated temperatures.

A number of workers have attempted to produce improved catalysts. Some of this are discussed below.

US Pat. No. 6,706,902 to Sturmann et al (assigned to Bayer AG) describes the production of nano-scale precious metal particles on SiH-containing support materials. These catalysts are described as being useful in the catalytic oxidation of hydrocarbons, such as the oxidation of propene.

The catalysts described in Sturmann et al has precious metal particles present in a form such that more 50% of the precious metal particles have a diameter of less than 10 nm. In this regard, Sturmann et al states that typically, only gold particles of less then 10 nm are catalytically active (gold being the preferred precious metal described in Sturmann et al). To manufacture the catalyst of Sturmann et al, a support material which has SiH groups is brought into contact with at least one precious metal compound and/or precious metal particles for a time span of less than 2 hours. The support material is the immediately dried using spray drying or fluidised bed drying.

Although Sturmann et al makes a brief statement that the process can also be used advantageously with SiH-free support materials to generate metal particles and/or metal oxide particles in the lower nano-scale range, no support is proved for this statement. Indeed, claim 1 of Sturmann et al is limited to a reasonably complex support composition containing SiH-groups.

Preferred uses of the catalyst of Sturmann et al is in the gaseous phase reaction of oxygen with hydrocarbons in the presence of hydrogen. In this case, epoxides are selectively obtained from olefins, ketones from saturated secondary hydrocarbons, and alcohols from saturated tertiary hydrocarbons.

U.S. Pat. No. 6,746,597 in the name of Zhou et al (assigned to Hydrocarbon Technologies, Inc.) describes supported nanometer-sized catalytic crystal particle compositions of noble metals, wherein the exposed faces of the nanometer-sized catalyst particles comprise predominantly crystal planes of the (111) type.

Zhou et al states that a large number of chemical transformations are accomplished using heterogeneous catalysts with the active component of the catalysts is a metal, often deposited on a support material. An important class of catalysts are those which utilise noble metals including the platinum group of metals (platinum, palladium, rhodium, ruthenium, iridium and osmium) as well as silver, gold and rhenium. In comparison to other catalytic materials, noble metals often have a especially high activity and selectivity and are, therefore, frequently preferred over other catalyst materials.

Because of their ability to facilitate the dissociative absorption, surface reaction and recombination/desorption of hydrogen, noble metals can catalyse a wide range of commercially important reactions, particularly the transfer, reaction or activation of hydrogen. These reactions and associated processes include various hydrogenations and related reactions such as methanation, carbonylation, hydroformylation, reductive alkylation, amination, hydrosilation, ammonia synthesis, oil or fat hardening and the like. Noble metal catalysis is also particularly useful in dehydrogenation reactions such as catalytic reforming, dehydrohalogenation reactions, steam reforming, partial oxidation and the production of gases including synthesis gas, hydrogen, carbon monoxide, carbon dioxide and the like. Noble metals are also used in important electrochemical processes such as fuel cell applications.

Despite their wide ranging effectiveness in catalytic chemical processes, Zhou et al states that noble metal catalysts have critical liabilities as the catalyst of choice for commercial chemical operations. Noble metals are extremely high cost and high catalyst attrition rates in given chemical process can negate the choice of noble metals as a preferred catalyst for that process. According to Zhou et al, their high cost also requires that their superior catalytic activity be sufficiently high compared to other catalyst choices to justify their use. To ameliorate the cost disadvantage, those skilled in the art can employ noble metal catalysts as small particles where by the overall efficiency of the catalyst is improved. This results in the greatest exposure of active noble metal surface areas for a given loading and offers the greatest noble metal utilisation. However, the high surface energy of the small particles tends to cause migration and agglomeration of the metal particles such that a catalyst which initially comprises very small particles and high noble metal surface area can lose surface area. Zhou et al states that improved methods are needed to prevent this migration and agglomeration of catalyst particles.

Zhou et al has discovered that supported nanometer scale noble metal particles containing a preponderance of (111) type of crystal phase upon the crystal face of the catalyst particles are especially effective catalysts. The support material for the noble metal catalyst is preferably a porous material such as porous alumina or carbon black. The particles of the invention described in Zhou et al preferably comprise noble metal particles of less then 5 nanometers, more preferably less then 2 nanometers. An important aspect of the invention of Zhou et al is the discovery that the most effective crystal phase of the noble metal particles useful in the selective reactions have a predominant exposure of the (111) type of crystal phase. Yet another important aspect of the invention of Zhou et al is the finding that the nanometer scale noble metal particles are anchored to the surface of the supporting substrate in a way that prevents this subsequent migration and agglomeration. Thus, the catalyst of Zhou et al includes the following advantages over other catalysts:
(a) A higher activity derived from the increased noble metal surface area of the extremely small crystallites containing the selective exposure of predominantly the (111) type of crystal phase upon the noble metal faces;
(b) Higher selectivity due to the selective exposure of the (111) type of crystal phase upon the noble metal crystal faces;
(c) An improved catalytic stability and life due to the anchoring of the noble metal crystallites. The strong anchoring of the crystallites to the substrate surface prevents a glomeration of metal particles into large structures, which would cause the disable high activity of the catalyst to be lost. Further, the strong anchoring substantially prevents the attrition of the active metal components into the surrounding liquid medium during use of the catalysts.

In order to form the catalysts of Zhou et al, a solution of a noble metal salt and a metallo-organic sequestering agent is formed. This solution is treated with a reducing agent. A catalyst support is then impregnated with the reduced noble metal solution and the impregnated support is dried. The catalyst is activated by reducing the dried impregnated support to yield the nanometer-sized noble metal catalysts having a preponderance of (111) type of crystal phase on the face of the noble metal particles. It seems that this process is required to obtain the strong anchoring of the noble metal crystallites to the substrate, as described in Zhou et al.

Zhou et al states that the noble metal particles are deposited on carbon or inorganic metal oxides support, minerals, polymeric materials and the like. Examples of noble metal catalyst supports are activated carbon, carbon black, fluoridated carbon, alumina, bentonite, clay, diatomaceous earth, zeolite, silica, zirconia, magnesia, titania, and the like, and also mixtures of those. The support is stated to be preferably a porous material having a surface area of more than 20 m²/g. Any material that can serve as a useful support for a heterogenous catalyst may be used a support material for the catalyst of Zhou et al.

U.S. Pat. No. 6,841,512 in the name of Fetcenko et al (assigned to Ovonic Battery Company, Inc.) describes an inexpensive catalytic material, especially non-platinum and non-palladium catalytic materials, as well as an inexpensive method for manufacturing that catalyst material. The catalyst is described as being useful in fuel cells, particularly for facilitating hydrogen consumption in a fuel cell anode.

The catalyst described in Fetcenko et al comprises a metal particulate having a particle size less than about 100 angstroms (less than about 10 nm) and support. The particulate may be affixed to the surface of the support. Alternately, the particulate may be partially or totally embedded into the support. The metal particulate is a plurality of metal particles. The catalytic metal particles are not limited to any particular shape, they may be regularly shaped or irregularly shaped. Examples of particle shapes (for the metal particles) include spherical, elongated, thread-like, and “sponge-like”.

Fetcenko et al describes certain embodiments of the invention as having the metal particles situated in close proximity to one another so that the particulate has a high density and hence, a high density of catalytic activity. The particulate may have an average proximity that is preferably between about 2 and about 300 angstroms, and more preferably between 50 to about 100 angstroms.

Fetcenko et al states that generally, any support conventionally known in the art, capable of supporting and providing adequate dispersion of the particulate, may be used. The support is described as being one or more inorganic oxides, zeolites, fine grained oxides, course grained oxides or a mixture of fine grained and course grained oxides, a halide such as a chloride, a phosphide, or a nitride.

Although Fetcenko et al describes a wide range of possible supports, the only method of manufacturing the catalyst described in Fetcenko et al involves providing a hydrogen storage alloy and leaching that alloy such that the bulk of the alloy is converted to its equivalent metal oxide. However, parts of the alloy that are resistant to oxidation by the leaching solution remain as metal particles and it is these metal particles that form the metal particles sized less than 100 angstroms. Thus, Fetcenko et al states that by first formulating a hydrogen absorbing alloy material with an appropriate composition and then subjecting this alloy to a leaching process having the appropriate leaching conditions (i.e. time of leaching as well as temperature and pH of the leaching material), substantially the entire starting alloy may be oxidised to form a highly catalytic material comprising a nickel and/or nickel alloy particulate embedded in an oxide support.

US Patent Application Publication No. 2005/0009696 in the name of Mao et al (assigned to 3M Innovative Properties Company), describes a supported catalyst having exceptionally small catalyst nanoparticles deposited on support particles in relatively high loading ratios. More particularly, the supported catalyst of Mao et al comprises catalyst metal nanoparticles having an average particle size of 3.0 nm or less which are supported on support particles, wherein the weight of catalysts metal nanoparticles in the supported catalyst is 30% or more of the weight of the supported catalyst. According to Mao et al, the invention described therein provides a supported catalyst having exceptionally small catalyst nanoparticles deposited on support particles in relatively high loading ratios and methods of making such supported catalysts by depositing unprotected catalyst nanoparticles on support particles. As used in Mao et al, “unprotected”, as used in reference to colloids of metal nanoparticles in organic or aqueous solvent means dispersed in weakly coordinating or non-coordinating solvent without protecting agents such as surfactants, polymers, or organic ligands.

Mao et al states that any suitable catalyst metal may be used. Typical catalyst metals are selected from platinum, palladium, ruthenium, rhodium, iridium, osmium, molybdenum, tungsten, iron, nickel and tin. Any suitable support particles may be used. Typical support particles are carbon, but may also be silica or other porus materials.

According to Mao et al, conventional methods of producing supported precious metal catalysts are typically unable to produce high loadings without concomitant increases in particle size. The increases in particle size limits the usefulness of the catalysts by reducing available surface area. Typical conventional methods include direct reduction of precious metals salts with reducing agents in the presence of a support, such as porous carbon or molecular sieve materials.

The method for making the catalyst described in Mao et al comprises the steps of providing a solution of metal chlorides of one or more catalyst metals in a solvent system containing at least one polyalcohol, forming a colloidal suspension of unprotected catalyst metal nanoparticles by raising the pH of the solution and heating the solution, adding support particles to the colloidal suspension and depositing the unprotected catalyst metal nanoparticles on the support particles by lowering the pH of the suspension, typically to a pH of 6.5 or lower.

The catalysts described in Mao et al are stated to be useful in electro chemical cells such as fuel cells.

U.S. Pat. No. 6,857,431 in the name of Deevi et al (assigned to Philip Morris USA Inc.) describes nanocomposite copper-ceria catalysts for low temperature or near ambient oxidation of carbon monoxide, reduction of nitric oxide and/or conversion of hydrocarbons. Deevi et al describes a method for making nanocomposite copper-ceria catalysts which comprises combining ceria nanoparticles in an aqueous suspension with copper 2, 4-pentanedionate to form a slurry. The slurry is heated under an inert gas atmosphere of an oxygen-argon atmosphere at a temperature and for a time sufficient to cause decomposition of the copper 2, 4-pentanedionate to form copper nanoparticles and/or copper oxide nanoparticles are combined with the ceria nanoparticles. The so-formed product may be subsequently heat treated at a temperature of from 300-400° C.

The nanocomposite copper-ceria catalyst thus produced comprises copper oxide nanoparticles, copper nanoparticles or a mixture thereof combined with ceria nanoparticles. The nanocomposite copper-ceria catalyst may be less than about 500 nm in size, preferably less than about 100 nm in size, more preferably less than about 10 nm in size and most preferably less than about 5 nm in size.

The nanocomposite copper-ceria catalyst may be carried by catalyst support. Examples of the catalyst support include aluminum, alumina, titanium, titania, zirconia, magnesia, silica, silica gel, activated carbon, carbon fibers, carbon foam, and/or mixtures thereof. The nanocomposite copper-ceria catalyst can be deposited on the support catalyst or combined with catalyst support particles.

The catalyst particles described in Deevi et al are stated to be particularly useful in smoking articles, such as cigarettes. In particular, the catalyst particles can be mixed with the filter or formed into the filter paper or incorporated into the fibrous material of the cigarette filter portion.

International Patent Application No. WO 2005/002714, filed in the name of William Marsh Rice University, describes a process for making a porous catalyst. The process comprises providing an aqueous solution containing a nanoparticle precursor, forming a composition containing nanoparticles, adding a first catalytic component or precursor thereof and a pore forming agent to the composition containing nanoparticles and allowing the first catalytic component, the pore forming agent, and the nanoparticles to form an organic-inorganic structure, removing water from the organic-inorganic structure, and removing the pore forming agent from the organic-inorganic structure so as to yield a porous catalyst.

In preferred embodiments, a metal oxide precursor is mixed with nanoparticles of a metal oxide support in a solution that contains a surfactant. The surfactant serves as a template for the metal oxide particles, which in turn support a self-assembled layer of the precursor salt species to the desired metal oxide layer. Once the nanoparticles, metal salt precursor and surfactant have self assembled, calcinations converts the salt species into a metal oxide layer and removes the surfactant to leave a porous structure.

The process of this patent application relies upon supramolecular templating synthesis of catalyst systems that is believed to entail the cooperative electrostatic and hydrogen bonding interactions among three components in order for self assembly to occur. The method allows the formation of a layer of metal oxide that is amorphous, rather than microcrystalline. The method also requires an ageing step to allow the self-templating of the components to occur. The examples of this patent show that precipitates are formed during the ageing step, which precipitates are washed, dried, ground into a fine powder and calcined. One outcome of such self-assembly methods is that the pore size distributions in the product are very sharp, since the pore size is primarily determined by the diameter of the surfactant micelles.

It can be difficult, when preparing supported catalysts, to ensure adequate dispersion of the catalytically active species on the support particles. This can be especially problematical when the catalytically active species includes complex metal oxides, or metal oxides including other catalytically active species (such as platinum group metals).

### BRIEF DESCRIPTION OF THE INVENTION

In a first aspect, the present invention provides a method for forming a material comprising a metal oxide supported on a support particle, the method comprising the steps of:
a) providing a precursor mixture comprising a solution containing one or more metal cations and
   (i) a surfactant; or
   (ii) a hydrophilic polymer; said precursor mixture further including support particles; and
b) treating the precursor mixture from (a) above by heating to remove the surfactant or hydrophilic polymer and form metal oxide having nano-sized grains, wherein at least some of the metal oxide formed in step (b) is deposited on or supported by the support particles and the metal oxide has an oxide matrix that includes metal atoms derived solely from sources other than the support particles.

Suitably, the metal oxide has an oxide matrix that includes metal atoms derived solely from the metal cations.

It will be appreciated that there will be an interlayer between the surface of the support particle and the metal oxide regions supported on the support particles. This interlayer should not be considered to form part of the metal oxide matrix. Thus, even though the interlayer is likely to contain metal atoms from both the support particles and the metal cations, the atoms provided from the support particles in the interlayer do not form part of the metal oxide matrix.

The support particles are generally inert or unreactive with respect to the other components of the precursor mixture and do not take part in the reaction mechanism that forms the metal oxide phase(s).

The support particles may have a generally equiaxed particle shape. In other embodiments, non-equiaxed support particles may be used. The particles may be spherical. Alternatively, the particles may be in the form of plates or platelets. Other shape support particles may also be used. In further embodiments, branched support particles may be used.

The support particles suitably have a maximum particle size of up to 1000 nm. More suitably, the support particles have a maximum particle size that falls within the range of from about 20 nm to about 500 nm, more preferably from about 20 nm to about 200 nm. However, it will be appreciated that the support particles may include some particles that have a maximum particle size greater than these sizes without departing from the scope of the present invention.

The support particles may comprise any suitable support material. Examples of suitable support materials include metal oxides, mixed metal oxides, silicate materials, carbon-based materials, polymeric materials, clay materials, zeolites, layered double hydroxide materials and the like. Some examples of suitable support materials include alumina,, aluminum hydroxide, titania, zirconia, ceria, magnesia, mixed metal oxides including two or more of the previously mentioned metal oxides, natural zeolites, synthetic zeolites, bentonite, montmorollinite, diatomaceous earth, carbon black, activated carbon, and the like. It will be appreciated that this list is not exhaustive. A precursor of the support particles may be used as a starting material.

The support material is suitably resistant to the conditions to which the catalyst is exposed during use of the catalyst. For example, the support material should be resistant to one or more of elevated temperature, elevated pressure or reactive chemical environments. The most suitable support materials not only retain their physical and chemical integrity during use, they also exhibit stable morphology during use.

In some embodiments, the material may be a catalyst or a catalytic material. The catalytic material may comprise any suitable known catalytic metal oxide material. The metal oxide material may be catalytic by itself or it may include other catalytic material. The other catalytic material may be, for example, platinum group metals or other catalytically active metals such as copper, nickel and cobalt, or indeed any other catalytic material. The metal oxide material may be a single phase metal oxide material, a complex metal oxide material, a multi phase metal oxide material. The metal oxide material may include oxides of catalytically active metals, mixed metal oxides, complex metal oxides, perovskites and the like, and mixtures thereof. It will be appreciated that this list is not exhaustive and that the present invention encompasses any suitable catalytic active metal oxide material.

The catalytic material may include more than one catalytic material. For example, the catalytic material may include particles or regions of a platinum group metal and particles of a metal oxide or mixed oxide. The catalytic material may also include one type of catalytic material supporting another type of catalytic material. For example, the support material may support regions of a mixed metal oxide, which in turn may support one or more platinum group metals. Where other catalytic materials are also present, those catalytic materials or precursors thereof may be added to the precursor mixture. Alternatively, those catalytic materials or precursors thereof may be added to the catalyst after the metal oxide has been formed.

In some embodiments, the catalytic material may include one or more complex metal oxides. Some suitable metal oxides that may be incorporated as the catalytic material in the present invention include complex oxides in which the metal species are evenly mixed throughout the metal oxide matrix. The complex metal oxide phase may be a perovskite. The crystal structure is that of the mineral ‘Perovskite’, chemical formula CaTiO₃. There are numerous different compounds with the perovskite crystal structure, including SrTiO₃, YBa₂Cu₃Oₓ superconductor, and many La-based perovskites that are useful as catalysts and as electrodes in solid oxide fuel cells. La-based perovskites include LaMnO₃, LaCoO₃, LaFeO₃, and LaGaO₃

Various substitutions of different elements into the oxide lattice may be made to obtain desired physical properties. For example with perovskites, substitutions may be on the A site (e.g. Sr for La in LaMnO₃) and/or on the B site (e.g. Ni for Mn in LaMnO₃). Multiple elemental substitutions on either or both sites can be made to further tailor physical properties for specific applications. For example, a perovskite composition (Ln_{0.2}La_{0.4}Nd_{0.2}Ca_{0.2})(Mn_{0.9}Mg_{0.1})O₃, where Ln is approximately La_{0.598}Nd_{0.184}Pr_{0.81}Ce_{0.131}Ca_{0.002}Sr_{0.004}, is described in U.S. Pat. No. 5,932,146 as being useful for solid oxide fuel cell electrodes.

The complex oxide material may include an oxide composition represented by the general formula:

A₁₋ₓBₓMO₃

wherein

A is a mixture of lanthanide elements;

B is a divalent or monovalent cation;

M is an element or mixture of elements selected from the group consisting of elements of an atomic number from 22 to 32, 40 to 51, and 73 to 83; and

x is a number in the range 0.1≦x≦0.5.

Another family of metal oxides that may be used as the catalytic material in the present invention are metal oxides incorporating cerium. Oxides containing cerium and zirconium are particularly useful for automobile catalysts. These oxides may be expressed as CeₐZr_{b}X_{c}O_{d}, where X is an element or a mixture of elements selected form the group consisting of elements of an atomic number of 22 to 32, 40 to 51, and 73 to 83.

The metal oxide material deposited on or supported by the support particles suitably has a grain size substantially in the range from 1-250 nm. Preferably, the grain size falls within the range of 1-100 nm, more preferably 1-50 nm, more preferably 1-20 nm, even more preferably 2-10 nm, most preferably 2-8 nm. The metal oxide material deposited on the support particles is preferably deposited in the form of small discrete regions that are separated from other regions of metal oxide material.

The material in accordance with the present invention may have a pore volume, following treatment at 500° C. for 2 hours, for pores having a diameter falling within the range of 2-200 nm, of from 0.50-2.10 cm³/g, more preferably from 0.75-1.50 cm³/g, even more preferably from 0.85-1.25 cm³/g. The catalyst may have a pore volume, following treatment at 500° C. for 2 hours, for pores having a diameter falling within the range of 10-200 nm, of from 0.46 to 1.84 cm³/g, more preferably from 0.69 to 1.38 cm³/g, even more preferably from 0.78 to 1.15 cm³/g. The catalyst may have a pore volume, following treatment at 500° C. for 2 hours, for pores having a diameter falling within the range of 50-200 nm, of from 0.20 to 0.8 cm³/g, more preferably from 0.3 to 0.6 cm³/g, even more preferably from 0.34 to 0.5 cm³/g.

The material may have a pore volume, following treatment at 1000° C. for 2 hours, for pores having a diameter falling within the range of 2-200 nm, of from 0.47 to 1.90 cm³/g, more preferably from 0.71 to 1.43 cm³/g, even more preferably from pore volume, even more preferably from 0.80 to 1.19 cm³/g. The material may have a pore volume, following treatment at 1000° C. for 2 hours, for pores having a diameter falling within the range of from 10-200 nm, of from 0.45 to 182 cm³/g, more preferably from 0.68 to 1.37 cm³/g, even more preferably from 0.77 to 1.14 cm³lg. The material may have a pore volume, following treatment at 1000° C. for 2 hours, for pores having a diameter falling within the range of 50-200 nm, of from 0.15-0.6 cm³/g, more preferably 0.22-0.45 cm³/g, even more preferably from 0.25 to 0.38 cm³/g.

Step (a) of the process of the present invention involves the preparation of a solution containing one or more metal cations. The metal cations are chosen according to the required composition of the metal oxide phase(s). The solution of one or more metal cations is preferably a concentrated solution. The inventors presently believe that a high concentration of dissolved metal is preferred for achieving the highest yield of product.

A very large number of metal cations may be used in the present invention. Examples include metals from Groups 1A, 2A, 3A, 4A, 5A and 6A of the Periodic Table, transition metals, lanthanides and actinides, and mixtures thereof. This list should not be considered to be exhaustive. The mixture may contain one or more different metal cations. Some examples of metals that are suitable for use in the present invention include cerium, zirconium, aluminum, yttrium, magnesium, titanium, chromium, manganese, cobalt, nickel, copper, zinc, aluminum, strontium, niobium, molybdenum, platinum group metals (including Pt, Pd, Rh, Re), gold, silver and metals from the lanthanide series. It will be appreciated that the present invention should not be considered to be limited solely to this list of metals.

The metal cation solution is suitably produced by mixing a salt or salts containing the desired metal(s) with a solvent. Any salt soluble in the particular solvent may be used, The metal cation solution may also be produced by mixing a metal oxide or metal oxides or a metal or metals with appropriate solvent(s).

A number of solvents can be used to prepare the metal cation solution. The solvents are preferably aqueous-based solvents. Examples of suitable solvents include water, nitric acid, hydrochloric acid, sulphuric acid, hydrofluoric acid, other inorganic acids, ammonia, alcohols, acetic acid, formic acid, other organic acids and mixtures thereof. This list should not be considered exhaustive and the present invention should be considered to encompass the use of all suitable solvents.

It is preferred that the support particles are evenly dispersed through the precursor mixture prior to the heat treatment step of step (b). hi this regard, the precursor mixture produced in step (a) may be suitably treated to disperse the particulate material therethrough. Many techniques for dispersion of particles in liquids are known. Dispersion may be achieved by control of solution characteristics (e.g. pH, temperature, addition of specific dispersants) together with appropriate mixing techniques. Mixing may be achieved by using any suitable known mixing apparatus, including high speed impellers, flow mixers, roll mills and ultrasonic mixers. The support particles may be dispersed after the solution has been formed. Alternatively, the particulate material may be mixed with the soluble metal compound(s) prior to addition of the solute to form the solution. As a further alternative, the particles may be dispersed in water or other solution and the metal salt(s) or metal cation solution subsequently added to the dispersion of particles.

The method may involve dispersing the support particles in a solution having pH that promotes dispersion and minimises aggregation of the support particles, followed by mixing that dispersion with a solution or mixture containing the one or more precursors of the catalytic material. The pH of the solution in which the support particles are dispersed is dependent upon the type of particles being dispersed in the solution. It will be understood that the support particles should not be detrimentally affected by the preparation conditions used. For example, the particles should not undesirably dissolve under the pH conditions used (or, to put it another way, the pH conditions should be selected such that dissolution of the support particles is minimal). It has been found by the present inventors that the step of dispersing the support particles in the solution prior to mixing with the one or more precursors of the catalytic material tends to result in a better distribution of catalytic material on the support particles with less aggregation of the support particles.

The surfactant or hydrophilic polymer may be added at any appropriate stage. Preferably, the surfactant or hydrophilic polymer are added after the support particles have been dispersed.

In some embodiments, step (b) of the present invention involves treating the mixture such that the dissolved metal cations initially form a solid precursor phase intermixed with the support particles. The solid precursor phase then forms the complex metal oxide phase or phases supported by or deposited on the support particles.

The heating step in step (b) encompasses any heat treatment that results in the formation of the metal oxide(s). The heating step may involve heating to an elevated temperature, for example, from 200° C. to 1000° C., preferably from 300° C. to 900° C. The actual temperatures and duration of heating is somewhat dependent upon the particular oxides being produced. The skilled person would readily be able to ascertain the required temperature and heating times required to form any particular metal oxide.

The method of the present invention is particularly suitable for use with the process described in our International patent application no. PCT/AU01/01510, the entire contents of which are herein incorporated by cross reference. In that process, a surfactant is suitably added in an amount sufficient to produce a micellar liquid.

A micellar liquid is formed when surfactant is added in sufficient quantity such that the surfactant molecules aggregate to form micelles. In a micellar liquid, micelles do not exhibit a significant degree of order, therefore the viscosity of the liquid is usually much less than that of more ordered liquid crystal phases, which are commonly gel-like. Use of micellar liquids as opposed to liquid crystals therefore enables simple, rapid and thorough mixing of the solution and surfactant, which is important for commercial production processes. In some embodiments, the amount of surfactant mixed with the solution is sufficient to produce a micellar liquid in which the micelles are closely spaced. The conditions under which the micellar liquid is formed will depend upon the particular surfactant(s) being used. In practice, the main variables that need to be controlled are the amount of surfactant added and the temperature. For some surfactants, the temperature should be elevated, whilst for others room temperature or below is necessary.

Any surfactant capable of forming micelles may be used in the present invention. A large number of surfactants may be used in the invention, including non-ionic surfactants, cationic surfactants, anionic surfactants and zwitteronic surfactants. Some examples include Brij C₁₆H₃₃(OCH₂CH₂)₂OH, designated C₁₆EO₂, (Aldrich); Brij 30, C₁₂EO₄, (Aldrich); Brij 56, C₁₆EO₁₀, (Aldrich); Brij 58, C₁₆EO₂₀, (Aldrich); Brij 76, C₁₈EO₁₀, (Aldrich); Brij 78, C₁₆EO₂₀, (Aldrich); Brij 97, C₁₈H₃₅EO₁₀, (Aldrich); Brij 35, C₁₂EO₂₃, (Aldrich); Triton X-100, CH₃C(CH₃)₂CH₂C(CH₃)₂C₆H₄(OCH₂CH₂)ₓOH,x=10(av), (Aldrich); Triton X-114, CH₃C(CH₃)₂CH₂C(CH₃)₂C₆H₄(OCH)₂CH₂)₅OH (Aldrich); Tween 20, poly(ethylene oxide) (20) sorbitan monokayrate (Aldrich); Tween 40, poly(ethylene oxide) (20) soribtan monopalmitate (Aldrich); Tween 60, poly(ethylene oxide) (20) sorbitan monostearate (Aldrich); Tween, poly(ethylene oxide) (20) sorbitan monooleate (Aldrich); and Span 40, sorbitan monopalmitate (Aldrich), Terital TMN 6, CH₃CH(CH₃)CH(CH₃)CH₂CH₂CH(CH₃)(OCH₂CH₂)₆OH (Fulka); Tergital TMN 10, CH₃CH(CH₃)CH(CH₃)CH₂CH₂CH(CH₃)(OCH₂CH₂)₁₀OH (Fulka); block copolymers having a poly(ethylene oxide)-poly(propylene oxide)-poly(ethylene oxide) (EO-PO-EO) sequence centered on a (hydrophobic) poly(propylene glycol) nucleus terminated by two primary hydroxyl groups; Pluronic L121 (_{Mav}=4400), EO₅PO₇₀EO₅ (BASF); Pluronic L64 (_{Mav}=2900), EP₁₃PO₃₀EO₁₃ (BASF); Pluronic P65 (_{Mav}=3400), EP₂₀PO₃₀EO₂₀ (BASF); Pluronic P85 (_{Mav}=4600), EO₂₆PO₃₉EO₂₆ (BASF); Pluronic P103 (_{Mav}=4950), EO₁₇PO₅₆EO₁₇ (BASF); Pluronic P123 (_{Mav}=5800), EO₂₀PO₇₀EO₂₀, (Aldrich); Pluronic F68 (_{Mav}=8400), EO₅₀PO₃₀EO₈₀ (BASF); Pluronic F127 (_{Mav}=12600), EO₁₀₆PO₇₀EO₁₀₆ (BASF); Pluronic F88 (_{Mav}=11400), EO₁₀₀PO₃₉EO₁₀₀ (BASF); Pluronic 25R4 (_{Mav}=3600), PO₁₉EO₃₃PO₁₉ (BASF); star diblock copolymers having four EOₙ-POₘ chains (or in reverse, the four POₙ-EOₘ chains) attached to an ethlenediamine nucleus, and terminated by secondary hydroxyl groups; Tetronic 908 (_{Mav}=25000), (EO₁₁₃PO₂₂)₂NCH₂CH₂N(PO₁₁₃EO₂₂)₂ (BASF); Tetronic 901 (_{Mav}=4700), (EO₃PO₁₈)₂NCH₂CH₂N(PO₁₈EO₃)₂ (BASF); and Tetronic 90R4 (_{Mav}=7240), (PO₁₉EO₁₆)₂ NCH₂CH₂N(EO₁₆PO₁₉)₂ (BASF)

The above surfactants are non-ionic surfactants. Other surfactants that can be used include:

Anionic surfactant:

Sodium dodecyl sulfate CH₃(CH₂)₁₁OSO₃NA

There appears to be several manufacturers. Sigma is an example.

Cationic surfactants:

Cetyltrimethylarnmonium chloride CH₃(CH₂)₁₅N(CH₃)₃Cl Aldrich

Cetyltrimethylammonium bromide CH₃(CH₂)₁₅N(CH₃)₃BT Aldrich

Cetylpyridinium chloride C₂₁H₃₈NCl Sigma.

This list should not be considered to be exhaustive.

Step (b) of the method of this embodiment of the present invention typically involves heating of the mixture from step (a) to an elevated temperature to thereby form the metal oxide phases deposited on or supported by the support particles. This step may optionally be preceded by a step of treating the surfactant/liquid mixture to form a gel. Commonly, the gel forms due to ordering of the micelles to form a liquid crystal. Typically, it is sufficient to change the temperature of the mixture to form the gel. For some mixtures, cooling will result in gel formation. For other mixtures, heating will result in gel formation. This appears to be dependent upon the surfactant(s) used.

If the optional step of forming a gel is used in the method, the heating of step (b) involves heating the gel.

The heating step results in the formation of the metal oxide and the pore structure of the particles. The heating step encompasses any heat treatment that results in the formation of the metal oxide(s). The heating step may involve heating to an elevated temperature, for example, from 200° C. to 1000° C. The actual temperatures and duration of heating is somewhat dependent upon the particular oxides being produced. The skilled person would readily be able to ascertain the required temperature and heating times required to form any particular metal oxide.

The present inventors believe that the process of the present invention may involve localised exothermic reactions occurring, which could lead to highly localised temperatures. However, it remains a significant advantage of the present invention that the applied temperature is relatively low compared to prior art processes known to the inventors.

The heating step may involve a rapid heating to the maximum desired temperature, or it may involve a much more closely controlled heat treatment regime. For example, the heating step may be carried out under a controlled atmosphere. The heating step may involve heating to a drying temperature (generally below the boiling temperature of the mixture) to dry the mixture, followed by a slow ramp up to the maximum applied temperature, or followed by a series of incremental increases to intermediate temperatures before ultimately reaching the maximum applied temperature. The duration of the heating step may vary widely, with a preferred time in step (c) being from 15 minutes to 24 hours. It will be appreciated that step (b) is intended to encompass all heating profiles that result in the formation of metal oxide phases.

The heating step (b) of the present invention encompasses all such heating steps that result in the formation of the desired metal oxide. The heating step may be carried out using heating apparatus known by the person of skill in the art to be suitable for such purposes. Examples include hot plates or other heated substrates, ovens, stationary table furnaces, rotary table furnaces, induction furnaces, fluid bed furnaces, bath furnaces, flash furnaces, tube furnaces, infrared furnaces, muffle furnaces, drop furnaces, belt furnaces, rotary furnaces, rotary kilns, rotary dryers, spray dryers, spin-flash dryers, drum dryers, reaction vessels, and flash calciners.

The present invention may also be practised by preparing a mixture of a metal cation-containing solution and a hydrophilic polymer and the support particles and subsequently heating the mixture to form metal oxide deposited on or supported on the support particles. In this embodiment, the solution containing metal cations is suitably an aqueous solution of one or more metal salts. The metal salts may be selected from the group consisting of chlorides, carbonates, hydroxides, isopropoxides, nitrates, acetates, epoxides, oxalates, and mixtures thereof. The hydrophilic polymers may be selected from hydrophilic organic materials such as carbohydrates (sucrose starches and cellulose) and carbohydrate derivatives, hydrophilic homopolymer and copolymers of ethylene oxide, 2-hydroxethylenemethacrylate, hydroxyalkylmethacrylates, hydroxyalkylacrylates, acrylamide, and n-vinylpyrrolidone; hydrophilic polymers such as polyurethanes, polyurethane-acrylic, and polyurethane-methacrylic copolymers and interpenetrating polymer networks; and proteins derived from animal-protein-gelatins; and mixtures thereof.

The above lists should not be considered to be limiting.

In all aspects of the process of the present invention, it may be desirable to add a pore-forming material to the mixture to form a porous complex metal oxide having a desired pore structure. In this embodiment, the pore-forming material is added to the mixture prior to forming the complex metal oxide and removed from the complex metal oxide either during the step of forming the metal oxide or after formation of the metal oxide to leave a porous complex metal-oxide. The pore-forming material may be polymer-based pore formers, polymer-based particles such as latex, salts or other particles such as carbon black. The pore forming material may be selected to provide pore sizes in the range of approximately 7 nm to 250 nm. The pore forming material is suitably selected to produce a porous complex metal oxide exhibiting enhanced high temperature stability.

### EXAMPLES

### Example 1

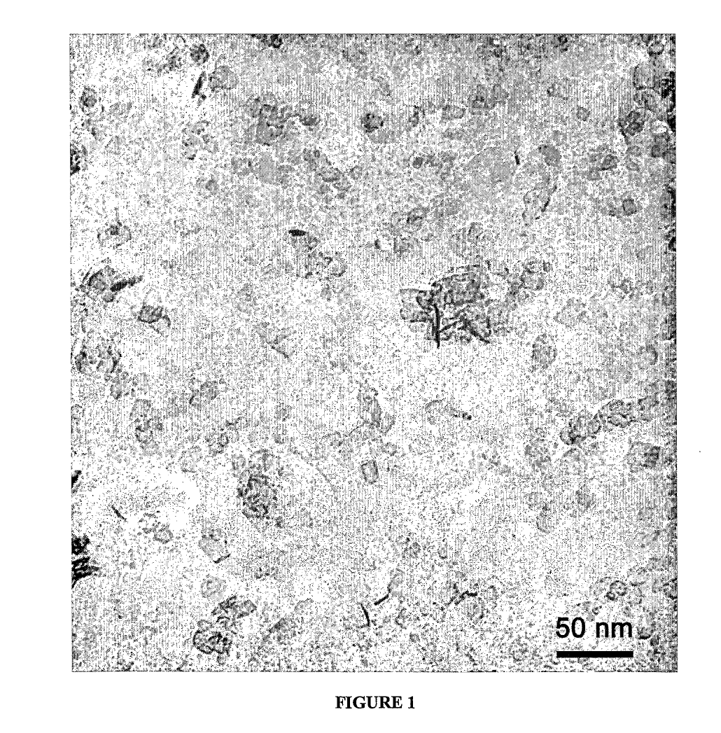

A composition 20 wt % Ce_{0.53}Zr_{0.37}Pr_{0.06}La_{0.04}Oₓ on alumina was prepared in the following manner. Cerium nitrate hexahydrate, zirconium carbonate, lanthanum nitrate hexahydrate and praseodymium nitrate hexahydrate were dissolved in the appropriate proportions to make 4.5 g of Ce_{0.537}Zr_{0.375}La_{0.025}Pr_{0.063}O, in ˜15 g water. 27 g of boehmite (aluminum hydroxide) plate-shaped nanoparticles (Sasol, Dispal 23-N4 80) was dispersed in 200 g water. FIG. 1 shows a TEM photomicrograph of such a plate-shaped nanoparticle. The salt solution was added to the boehmite dispersion, then 16 g of carbon black (Raven 850, Columbian Chemicals) and mixed with a high-speed stirrer. 47 g of surfactant (Erunon LA4) was added and mixed. This final mixture was heated slowly to a temperature of 500° C., and then higher temperature testing was carried out for 2 h at 1000° C.

Following the heat treatment to 1000° C., XRD showed a ceria-containing phase and alumina. TEM showed the structure consisted of nano-sized particles of the catalyst phase dispersed throughout the alumina. The surface area was 104 m²/g, and the pore volume for pores between 2 nm and 200 nm was 1.05 cc/g.

### Example 2

A composition 20 wt % Ce_{0.53}Zr_{0.37}Pr_{0.06}La_{0.04}Oₓon alumina was prepared in a similar manner to example 1, except that polyethylene glycol was used instead of LA4 surfactant.

Following the heat treatment to 1000° C., XRD showed a ceria-containing phase and alumina. TEM showed the structure consisted of nano-sized particles of the catalyst phase dispersed throughout the alumina. The surface area was 103 m²/g, and the pore volume for pores between 2 nm and ˜200 nm was 0.89 cc/g.

### Example 3

A composition 20 wt % Ce_{0.53}Zr_{0.37}Pr_{0.06}La_{0.04}Oₓ on alumina was prepared in a similar manner to example 1, except that DISPAL 18BP was used instead of X-O.

Following the heat treatment to 1000° C., XRD showed a ceria-containing phase and alumina. TEM showed the structure consisted of nano-sized particles of the catalyst phase dispersed throughout the alumina. The surface area was 87.5 m²/g, and the pore volume for pores between 2 nm and ˜200 nm was 0.66 cc/g.

Those skilled in the art will appreciate that the present invention may be susceptible to variations and modifications other than those specifically described. It is to be understood that the present invention encompasses all such variations and modifications that fall within its spirit and scope.

1-35. (canceled)

36. A method for forming a material comprising a metal oxide supported on a support particle, the method comprising the steps of:
a) providing a precursor mixture comprising a solution containing one or more metal cations and (i) a surfactant; or (ii) a hydrophilic polymer; with the precursor mixture further including support particles; and
b) treating the precursor mixture from (a) above by heating to remove the surfactant or hydrophilic polymer and form metal oxide having nano-sized grains,
wherein at least some of the metal oxide formed in step (b) is deposited on or supported by the support particles and the metal oxide has an oxide matrix that includes metal atoms derived solely from sources other than the support particles.

37. The method as claimed in claim 36, wherein the metal oxide has an oxide matrix that includes metal atoms derived solely from the metal cations.

38. The method as claimed in claim 36, wherein the support particles are generally inert or unreactive with respect to the other components of the precursor mixture and do not take part in the reaction mechanism that forms the metal oxide phase(s).

39. The method as claimed in claim 36, wherein the support particles have a generally equiaxed or spherical particle shape and have a maximum particle size of up to 1000 nm.

40. The method as claimed in claim 36, wherein the support particles have a generally non-equiaxed particle shape or are in the form of plates, platelets or branched support particles and have a maximum particle size of up to 1000 nm.

41. The method as claimed in claim 36, wherein the support particles have a maximum particle size that falls within the range of from about 20 nm to about 200 nm.

42. The method as claimed in claim 36, wherein the support particles comprise support material selected from the group consisting of metal oxides, mixed metal oxides, silicate materials, carbon-based materials, polymeric materials, clay materials, zeolites, layered double hydroxide materials and mixtures thereof.

43. The method as claimed in claim 36, wherein the material is a catalytic material, either of itself or by including another catalytic material.

44. The method as claimed in claim 43, wherein the material includes another other catalytic material selected from the group consisting of platinum group metals, or other catalytically active metals.

45. The method as claimed in claim 36, wherein the metal oxide material comprises a single phase metal oxide material, a complex metal oxide material, or a multi phase metal oxide material.

46. The method as claimed in claim 36, wherein the metal oxide material deposited on or supported by the support particles has a grain size substantially in the range from 1-250 nm.

47. The method as claimed in claim 36, wherein the metal oxide material deposited on the support particles is deposited in the form of small discrete regions that are separated from other regions of metal oxide material.

48. The method as claimed in claim 36, wherein the solution containing one or more metal cations includes metal cations selected from the group consisting of an element from Groups 1A, 2A, 3A, 4A, 5A and 6A of the Periodic Table, a transition metal, a lanthanide, an actinide, and mixtures thereof.

49. The method as claimed in claim 48, wherein the solution contains different metal cations selected from the group consisting of one or more of cerium, zirconium, aluminum, yttrium, magnesium, titanium, chromium, manganese, cobalt, nickel, copper, zinc, strontium, niobium, molybdenum, platinum, palladium, rhodium, rhenium, gold, silver and a metal from the lanthanide series.

50. The method as claimed in claim 36, wherein the metal cation solution is produced by mixing a salt or salts containing the desired metal(s) with a solvent.

51. The method as claimed in claim 36, wherein the metal cation solution is produced by mixing a metal oxide or metal oxides or a metal or metals with one or more solvents.

52. The method as claimed in claim 36, wherein the solution includes a solvent selected from the group consisting of water, nitric acid, hydrochloric acid, sulphuric acid, hydrofluoric acid, other inorganic acids, ammonia, alcohols, acetic acid, formic acid, other organic acids and mixtures thereof.

53. The method as claimed in claim 36, wherein the support particles are evenly dispersed through the precursor mixture prior to the heat treatment step of step (b).

54. The method as claimed in claim 53, which further comprises dispersing the support particles in a solution having pH that promotes dispersion and minimizes aggregation of the support particles, followed by mixing that dispersion with a solution or mixture containing the one or more precursors of the catalytic material.

55. The method as claimed in claim 53, wherein the surfactant or hydrophilic polymer is added after the support particles have been dispersed.

56. The method as claimed in claim 36, wherein step (b) involves treating the mixture such that the dissolved metal cations initially form a solid precursor phase intermixed with the support particles and the solid precursor phase then forms the complex metal oxide phase or phases supported by or deposited on the support particles.

57. The method as claimed in claim 36, wherein a surfactant is added in an amount sufficient to produce a micellar liquid.

58. The method as claimed in claim 57, wherein step (b) involves heating of the mixture from step (a) to an elevated temperature to thereby form the metal oxide phases deposited on or supported by the support particles.

59. The method as claimed in claim 57, wherein step (b) is preceded by a step of treating the surfactant/liquid mixture to form a gel.

60. The method as claimed in claim 57, wherein the heating step involves heating the mixture to an elevated temperature of from 200° C. to 1000° C.

61. The method as claimed in claim 36, which comprises preparing a mixture of a metal cation-containing solution and a hydrophilic polymer and the support particles and subsequently heating the mixture to form metal oxide deposited on or supported on the support particles and the solution containing metal cations is an aqueous solution of one or more metal salts.

62. The method as claimed in claim 61, wherein the metal salts are selected from the group consisting of chlorides, carbonates, hydroxides, isopropoxides, nitrates, acetates, epoxides, oxalates, and mixtures thereof.

63. The method as claimed in claim 61, wherein the hydrophilic polymer is selected from hydrophilic organic materials such as carbohydrates, including sucrose starches and cellulose, and carbohydrate derivatives, hydrophilic homopolymer and copolymers of ethylene oxide, 2-hydroxethylenemethacrylate, hydroxyalkylmethacrylates, hydroxyalkylacrylates, acrylamide, and n-vinylpyrrolidone; hydrophilic polymers such as polyurethanes, polyurethane- acrylic, and polyurethane-methacrylic copolymers and interpenetrating polymer networks; and proteins derived from animal-protein-gelatins; and mixtures thereof.

64. The method as claimed in claim 36, which further comprises adding a pore-forming material to the mixture to form a porous complex metal oxide.
